(19) United States
(12) Patent Application Publication
(10) Pub. No.: US 2019/0096410 A1
(43) Pub. Date: Mar. 28, 2019

(54) Audio Signal Encoder, Audio Signal Decoder, Method for Encoding and Method for Decoding

(71) Applicant: Nokia Technologies Oy, Espoo (FI)

(72) Inventors: Adriana VASILACHE, Tempere (FI); Lasse Juhani LAAKSONEN, Tempere (FI); Anssi Sakari RAMO, Tempere (FI); Antti HURMALAINEN, Tempere (FI)

(21) Appl. No.: 16/080,339

(22) PCT Filed: Mar. 3, 2016
(86) PCT No.: PCT/EP2016/054591

§ 371 Date: Aug. 28, 2018

(51) Int. Cl. G10L 19/008; G10L 19/02; G10L 25/21

(52) U.S. Cl. CPC G10L 19/008; G10L 25/21; G10L 19/0204

(57) ABSTRACT

A method including determining a plurality of band energy scale values for a pair of audio signals; transforming the band energy scale values using a discrete cosine transform to generate a plurality of coefficient values; and selecting a sub-set of the plurality of coefficient values to generate a representation of a level difference between the pair of audio signals.

### FIELD

The present application relates to a multichannel or stereo audio signal encoder, and in particular, but not exclusively to a multichannel or stereo audio signal encoder for use in portable apparatus.

### BACKGROUND

Audio signals, like speech or music, are encoded for example to enable efficient transmission or storage of the audio signals.

Audio encoders and decoders (also known as codecs) are used to represent audio based signals, such as music and ambient sounds (which in speech coding terms can be called background noise). These types of coders typically do not utilise a speech model for the coding process, rather they use processes for representing all types of audio signals, including speech. Speech encoders and decoders (codecs) can be considered to be audio codecs which are optimised for speech signals, and can operate at either a fixed or variable bit rate.

An audio codec can also be configured to operate with varying bit rates. At lower bit rates, such an audio codec may be optimized to work with speech signals at a coding rate equivalent to a pure speech codec. At higher bit rates, the audio codec may code any signal including music, background noise and speech, with higher quality and performance. A variable-rate audio codec can also implement an embedded scalable coding structure and bitstream, where additional bits (a specific amount of bits is often referred to as a layer) improve the coding upon lower rates, and where the bitstream of a higher rate may be truncated to obtain the bitstream of a lower rate coding. Such an audio codec may utilize a codec designed purely for speech signals as the core layer or lowest bit rate coding.

An audio codec is designed to maintain a high (perceptual) quality while improving the compression ratio. Thus instead of waveform matching coding it is common to employ various parametric schemes to lower the bit rate. For multichannel audio, such as stereo signals, it is common to use a larger amount of the available bit rate on a mono channel representation and encode the stereo or multichannel information exploiting a parametric approach which uses relatively fewer bits.

### SUMMARY

There is provided according to a first aspect a method comprising: determining a plurality of band energy scale values for a pair of audio signals; transforming the plurality of band energy scale values using a discrete cosine transform to generate a plurality of coefficient values; and selecting a sub-set of the plurality of coefficient values to generate a representation of a level difference between the pair of audio signals.

The method may further comprise quantizing the sub-set of the plurality of coefficient values; and outputting or storing the quantized sub-set of the plurality of coefficient values as the representation of a level difference between the pair of audio signals.

The method may further comprise outputting or storing the sub-set of the plurality of coefficient values as the representation of a level difference between the pair of audio signals.

The method may further comprise determining on a band by band basis a first plurality of band energy values from a first of the pair of audio signals; and determining on a band by band basis a second plurality of band energy values from a second of the pair of audio signals, wherein determining the plurality of band energy scale values for the pair of audio signals comprises determining on a band by band basis a ratio of the first plurality of band energy values against the second plurality of band energy values.

The method may further comprise: determining first audio signal band representations from the first of the pair of audio signals; and determining second audio signal band representations from the second of the pair of audio signals, wherein determining on a band by band basis the first plurality of band energy values from a first of the pair of audio signals comprises on a band by band basis combining the first audio signal band representations, and determining on a band by band basis the second plurality of band energy values from a second of the pair of audio signals comprises on a band by band basis combining the second audio signal band representations.

Determining the first plurality of band energy values for the first of the pair of audio signals may comprise determining

$${e}_{b}^{L} = {\sum }_{f = 0}^{F - 1} {( {d}_{f}^{L} )}^{2} {a}_{f}^{( b )} ,$$

and determining the second plurality of band energy values for the second of the pair of audio signals comprises determining

$${e}_{b}^{R} = {\sum }_{f = 0}^{F - 1} {( {d}_{f}^{R} )}^{2 i} {a}_{f}^{( b )}$$

where e_{\dot{o}}^{L}, are filtered band energies of the first audio signal of the pair of audio signals, e_{\dot{o}}^{R} are filtered band energies of the second signal of the pair of audio signals, d_{f}^{L} are magnitudes of the first audio signal, d_{f}^{R}, are magnitudes of the second audio signal, a_{f}^{(b)} are a set of B (squared) frequency responses of equivalent length, where a number of bands are b∈[0, B−1].

Determining the plurality of band energy scale values for a pair of audio signals may comprise determining

$${s}_{b} = 10 {log}_{10} \frac{{e}_{b}^{L}}{{e}_{b}^{R}}$$

where s_{b} are the plurality of band energy scale values.

Transforming the band energy scale values using a discrete cosine transform to generate a plurality of coefficient values may comprise determining

$${c}_{k} = {w}_{k} {\sum }_{b = 0}^{B - 1} {s}_{b} cos [ \frac{π k}{B} ( b + \frac{1}{2} ) ]$$

where cₖ is the coefficient values and wₖ=1/B for k=0 and \sqrt{2}/B otherwise.

A method for encoding a multichannel audio signal, the method may comprise: generating a downmix for the multichannel audio signal;

generating at least one interchannel level difference value using the method as described herein; generating at least one interchannel temporal difference value; outputting the downmix, at least one interchannel level difference value and at least one interchannel temporal difference value.

According to a second aspect there is provided a method comprising: determining from an encoded audio signal: a plurality of coefficient values representing discrete cosine transformed band energy scale values; and a downmixed audio signal; inverse cosine transforming the plurality of coefficient values to generate a plurality of band energy scale values; and generating a pair of audio signals by applying the plurality of band energy scale values to the downmixed audio signal.

Generating a pair of audio signals by applying the plurality of band energy scale values to the downmixed audio signal may comprise upsampling the plurality of band energy scale values to a full spectral resolution.

Generating a pair of audio signals by applying the plurality of band energy scale values to the downmixed audio signal may comprise: generating an amplitude ratio for each band from the plurality of band energy scale values; applying the amplitude ratio for each band to an associated downmixed audio signal band to generate for each of the pair of audio signals a plurality of audio signal bands; and combining for each of the pair of audio signals the plurality of audio signal bands.

According to a third aspect there is provided an apparatus comprising: a scale generator configured to determine a plurality of band energy scale values for a pair of audio signals; a discrete cosine transformer configured to transform the plurality of band energy scale values using a discrete cosine transform to generate a plurality of coefficient values; a coefficient selector configured to select a sub-set of the plurality of coefficient values to generate a representation of a level difference between the pair of audio signals.

The apparatus may further comprise: a coefficient quantizer configured to quantize the sub-set of the plurality of coefficient values; and an output configured to output or a memory configured to store the quantized sub-set of the plurality of coefficient values as the representation of a level difference between the pair of audio signals.

The apparatus may further comprise an output configured to output or a memory configured to store the sub-set of the plurality of coefficient values as the representation of a level difference between the pair of audio signals.

The apparatus may further comprise an energy determiner configured to determine on a band by band basis a first plurality of band energy values from a first of the pair of audio signals; and determine on a band by band basis a second plurality of band energy values from a second of the pair of audio signals, wherein the scale generator is configured to determine on a band by band basis a ratio of the first plurality of band energy values against the second plurality of band energy values.

The apparatus may further comprise a first signal frequency band determiner configured to determine first audio signal band representations from the first of the pair of audio signals; and a second signal frequency band determiner configured to determine second audio signal band representations from the second of the pair of audio signals, wherein the energy determiner is configured to combine on a band by band basis the first audio signal band representations to generate the first plurality of band energy values, and further configured to combine on a band by band basis the second audio signal band representations to generate the second plurality of band energy values.

The at least one frequency band determiner may comprise a first filter bank configured to receive the first of the pair of audio signals to generate the first plurality of band energy values; and a second filter bank configured to receive the second of the pair of audio signals to generate the second plurality of band energy values.

The energy determiner may be configured to determine the first plurality of band energy values for the first of the pair of audio signals as

$${e}_{b}^{L} = {\sum }_{f = 0}^{F - 1} {( {d}_{f}^{L} )}^{2} {a}_{f}^{( b )} ,$$

and determine the second plurality of band energy values for the second of the pair of audio signals as

$${e}_{b}^{R} = {\sum }_{f = 0}^{F - 1} {( {d}_{f}^{R} )}^{2} {a}_{f}^{( b )}$$

where e_{\dot{o}}^{L}, are filtered band energies of the first audio signal of the pair of audio signals, e_{\dot{o}}^{R} are filtered band energies of the second signal of the pair of audio signals, d_{f}^{L} are magnitudes of the first audio signal, d_{f}^{R}, are magnitudes of the second audio signal, a_{f}^{(b)} are a set of B (squared) frequency responses of equivalent length, where a number of bands are b∈[0, B−1].

The scale generator may be configured to determine

$${s}_{b} = 10 {log}_{10} \frac{{e}_{b}^{L}}{{e}_{b}^{R}}$$

where s_{b} are the plurality of band energy scale values.

The discrete cosine transformer may be configured to determine

$${c}_{k} = {w}_{k} {\sum }_{b = 0}^{B - 1} {s}_{b} cos [ \frac{π k}{B} ( b + \frac{1}{2} ) ]$$

Where cₖ is the coefficient values and wₖ=1/B for k=0 and \sqrt{2}/B otherwise.

There may be provided an encoder for encoding a multichannel audio signal, the encoder may comprise: a downmix encoder configured to generate a downmix for the multichannel audio signal; a multichannel encoder comprising: the apparatus as discussed herein configured to generate at least one interchannel level difference value; an interchannel temporal difference value generator configured to generate at least one interchannel temporal difference value; an output configured to output or store the downmix, the at least one interchannel level difference value and the at least one interchannel temporal difference value.

According to a fourth aspect there is provided an apparatus for decoding comprising: a demix configured to determine from an encoded audio signal: a plurality of coefficient values representing discrete cosine transformed band energy scale values; and a downmixed audio signal; a multichannel decoder comprising: an inverse cosine transformer configured to inverse cosine transform the plurality of coefficient values to generate a plurality of band energy scale values; and an upmixer configured to generate a pair of audio signals by applying the plurality of band energy scale values to the downmixed audio signal.

The multichannel decoder may further comprise an inverse filterbank configured to upsample the plurality of band energy scale values to a full spectral resolution.

The multichannel decoder may further comprise a channel amplitude ratio determiner configured to generate an amplitude ratio for each band from the plurality of band energy scale values, wherein the upmixer may be configured to apply the amplitude ratio for each band to an associated downmixed audio signal band to generate for each of the pair of audio signals a plurality of audio signal bands and to combine the plurality of audio signal bands for each of the pair of audio signals.

According to a fifth aspect there is provided an apparatus comprising: means for determining a plurality of band energy scale values for a pair of audio signals; means for transforming the plurality of band energy scale values using a discrete cosine transform to generate a plurality of coefficient values; means for selecting a sub-set of the plurality of coefficient values to generate a representation of a level difference between the pair of audio signals.

The apparatus may further comprise means for quantizing the sub-set of the plurality of coefficient values; and means for outputting or storing the quantized sub-set of the plurality of coefficient values as the representation of a level difference between the pair of audio signals.

The apparatus may further comprise means for outputting or storing the sub-set of the plurality of coefficient values as the representation of a level difference between the pair of audio signals.

The apparatus may further comprise means for determining on a band by band basis a first plurality of band energy values from a first of the pair of audio signals; and means for determining on a band by band basis a second plurality of band energy values from a second of the pair of audio signals, wherein the means for determining the plurality of band energy scale values for the pair of audio signals comprises means for determining on a band by band basis a ratio of the first plurality of band energy values against the second plurality of band energy values.

The apparatus may further comprise means for determining first audio signal band representations from the first of the pair of audio signals; and means for determining second audio signal band representations from the second of the pair of audio signals, wherein the means for determining on a band by band basis the first plurality of band energy values from a first of the pair of audio signals may comprise means for, on a band by band basis, combining the first audio signal band representations, and the means for determining on a band by band basis the second plurality of band energy values from a second of the pair of audio signals may comprise means for, on a band by band basis, combining the second audio signal band representations.

The means for determining on a band by band basis the first plurality of band energy values from the first of the pair of audio signals may comprise means for passing the first audio signal through a first filterbank to generate the first plurality of band energy values, and the means for determining on a band by band basis the second plurality of band energy values from the second of the pair of audio signals may comprise means for passing the second audio signal through a second filterbank to generate the second plurality of band energy values.

The means for determining the first plurality of band energy values for the first of the pair of audio signals may comprise means for determining

$${e}_{b}^{L} = {\sum }_{f = 0}^{F - 1} {( {d}_{f}^{L} )}^{2} {a}_{f}^{( b )} ,$$

and the means for determining the second plurality of band energy values for the second of the pair of audio signals may comprise means for determining

$${e}_{b}^{R} = {\sum }_{f = 0}^{F - 1} {( {d}_{f}^{R} )}^{2} {a}_{f}^{( b )}$$

where e_{\dot{o}}^{L}, are filtered band energies of the first audio signal of the pair of audio signals, e_{\dot{o}}^{R} are filtered band energies of the second signal of the pair of audio signals, d_{f}^{L} are magnitudes of the first audio signal, d_{f}^{R}, are magnitudes of the second audio signal, a_{f}^{(b)} are a set of B (squared) frequency responses of equivalent length, where a number of bands are b∈[0, B−1].

The means for determining the plurality of band energy scale values for a pair of audio signals may comprise means for determining

$${s}_{b} = 10 {log}_{10} \frac{{e}_{b}^{L}}{{e}_{b}^{R}}$$

where s_{b} are the plurality of band energy scale values.

The means for transforming the plurality of band energy scale values using a discrete cosine transform to generate a plurality of coefficient values may comprise means for determining

$${c}_{k} = {w}_{k} {\sum }_{b = 0}^{B - 1} {s}_{b} cos [ \frac{π k}{B} ( b + \frac{1}{2} ) ]$$

where cₖ is the coefficient values and wₖ=1/B for k=0 and \sqrt{2}/B otherwise.

An encoder for encoding a multichannel audio signal, the encoder may comprise: means for generating a downmix for the multichannel audio signal; the apparatus as discussed herein configured to generate at least one interchannel level difference value; means for generating at least one interchannel temporal difference value; means for outputting the downmix, at least one interchannel level difference value and at least one interchannel temporal difference value.

According to a sixth aspect there is provided an apparatus comprising: means for determining from an encoded audio signal: a plurality of coefficient values representing discrete cosine transformed band energy scale values; and a downmixed audio signal; means for inverse cosine transforming the plurality of coefficient values to generate a plurality of band energy scale values; and means for generating a pair of audio signals by applying the plurality of band energy scale values to the downmixed audio signal.

The means for generating a pair of audio signals by applying the plurality of band energy scale values to the downmixed audio signal may comprise means for upsampling the plurality of band energy scale values to a full spectral resolution.

The means for generating a pair of audio signals by applying the plurality of band energy scale values to the downmixed audio signal may comprise: means for generating an amplitude ratio for each band from the plurality of band energy scale values; means for applying the amplitude ratio for each band to an associated downmixed audio signal band to generate for each of the pair of audio signals a plurality of audio signal bands; and means for combining for each of the pair of audio signals the plurality of audio signal bands.

There is provided according to a seventh aspect an apparatus comprising at least one processor and at least one memory including computer code for one or more programs, the at least one memory and the computer code configured to with the at least one processor cause the apparatus to at least perform: determine a plurality of band energy scale values for a pair of audio signals; transform the plurality of band energy scale values using a discrete cosine transform to generate a plurality of coefficient values; and select a sub-set of the plurality of coefficient values to generate a representation of a level difference between the pair of audio signals.

The apparatus may be further caused to perform quantize the sub-set of the plurality of coefficient values; and output or store the quantized sub-set of the plurality of coefficient values as the representation of a level difference between the pair of audio signals.

The apparatus may be further caused to output or store the sub-set of the plurality of coefficient values as the representation of a level difference between the pair of audio signals.

The apparatus may be further caused to determine on a band by band basis a first plurality of band energy values from a first of the pair of audio signals; and determine on a band by band basis a second plurality of band energy values from a second of the pair of audio signals, wherein determining the plurality of band energy scale values for the pair of audio signals may cause the apparatus to determine on a band by band basis a ratio of the first plurality of band energy values against the second plurality of band energy values.

The apparatus may be further caused to determine first audio signal band representations from the first of the pair of audio signals; and determine second audio signal band representations from the second of the pair of audio signals, wherein determining on a band by band basis the first plurality of band energy values from a first of the pair of audio signals may cause the apparatus to on a band by band basis combining the first audio signal band representations, and determine on a band by band basis the second plurality of band energy values from a second of the pair of audio signals comprises on a band by band basis combining the second audio signal band representations.

Determining on a band by band basis a first plurality of band energy values from the first of the pair of audio signals may cause the apparatus to pass the first audio signal through a first filterbank to generate the first plurality of band energy values, and determining on a band by band basis the second plurality of band energy values from the second of the pair of audio signals may cause the apparatus to pass the second audio signal through a second filterbank to generate the second plurality of band energy values.

Determining the first plurality of band energy values for the first of the pair of audio signals may cause the apparatus to determine

$${e}_{b}^{L} = {\sum }_{f = 0}^{F - 1} {( {d}_{f}^{L} )}^{2} {a}_{f}^{( b )} ,$$

and determining the second plurality of band energy values for the second of the pair of audio signals may cause the apparatus to determine

$${e}_{b}^{R} = {\sum }_{f = 0}^{F - 1} {( {d}_{f}^{R} )}^{2} {a}_{f}^{( b )}$$

where e_{\dot{o}}^{L}, are filtered band energies of the first audio signal of the pair of audio signals, e_{\dot{o}}^{R} are filtered band energies of the second signal of the pair of audio signals, d_{f}^{L} are magnitudes of the first audio signal, d_{f}^{R}, are magnitudes of the second audio signal, a_{f}^{(b)} are a set of B (squared) frequency responses of equivalent length, where a number of bands are b∈[0, B−1].

Determining a plurality of band energy scale values for a pair of audio signals may further cause the apparatus to perform determine

$${s}_{b} = 10 {log}_{10} \frac{{e}_{b}^{L}}{{e}_{b}^{R}}$$

where s_{b} are the plurality of band energy scale values.

Transforming the band energy scale values using a discrete cosine transform to generate a plurality of coefficient values may further cause the apparatus to perform determine

$${c}_{k} = {w}_{k} {\sum }_{b = 0}^{B - 1} {s}_{b} cos [ \frac{π k}{B} ( b + \frac{1}{2} ) ]$$

where cₖ is the coefficient values and wₖ=1/B for k=0 and \sqrt{2}/B otherwise.

An apparatus for encoding a multichannel audio signal may comprise: the at least one processor and at least one memory including computer code for one or more programs caused to generate at least one interchannel level difference value as described herein, the apparatus further caused to perform generate a downmix for the multichannel audio signal; generate at least one interchannel temporal difference value; and output the downmix, at least one interchannel level difference value and at least one interchannel temporal difference value.

According to an eighth aspect there is provided an apparatus comprising the at least one memory and the computer code configured to with the at least one processor cause the apparatus to at least perform: determine from an encoded audio signal: a plurality of coefficient values representing discrete cosine transformed band energy scale values; and a downmixed audio signal; inverse cosine transform the plurality of coefficient values to generate a plurality of band energy scale values; and generate a pair of audio signals by applying the plurality of band energy scale values to the downmixed audio signal.

Generating a pair of audio signals by applying the plurality of band energy scale values to the downmixed audio signal may cause the apparatus to perform upsampling the plurality of band energy scale values to a full spectral resolution.

Generating a pair of audio signals by applying the plurality of band energy scale values to the downmixed audio signal may cause the apparatus to perform: generate an amplitude ratio for each band from the plurality of band energy scale values; apply the amplitude ratio for each band to an associated downmixed audio signal band to generate for each of the pair of audio signals a plurality of audio signal bands; and combine for each of the pair of audio signals the plurality of audio signal bands.

A computer program product may cause an apparatus to perform the method as described herein.

An electronic device may comprise apparatus as described herein.

A chipset may comprise apparatus as described herein.

### BRIEF DESCRIPTION OF DRAIN

For better understanding of the present invention, reference will now be made by way of example to the accompanying drawings in which:

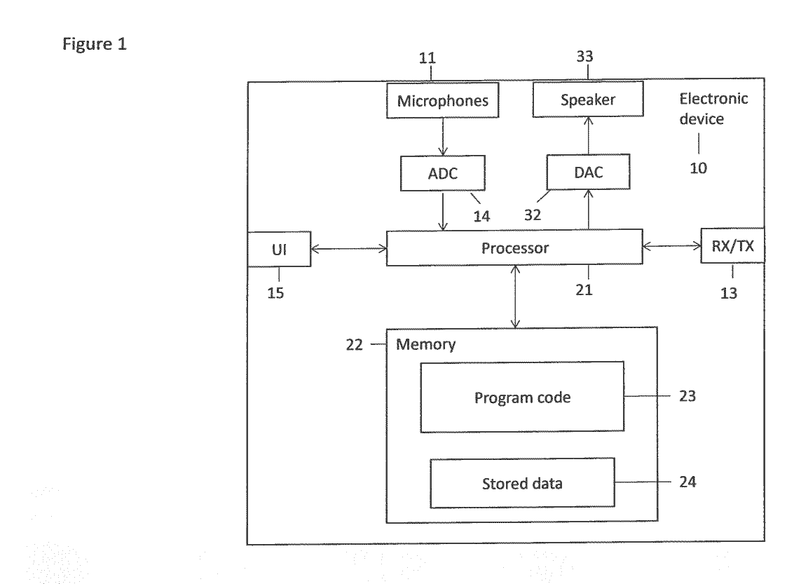

FIG. 1 shows schematically an electronic device employing some embodiments;

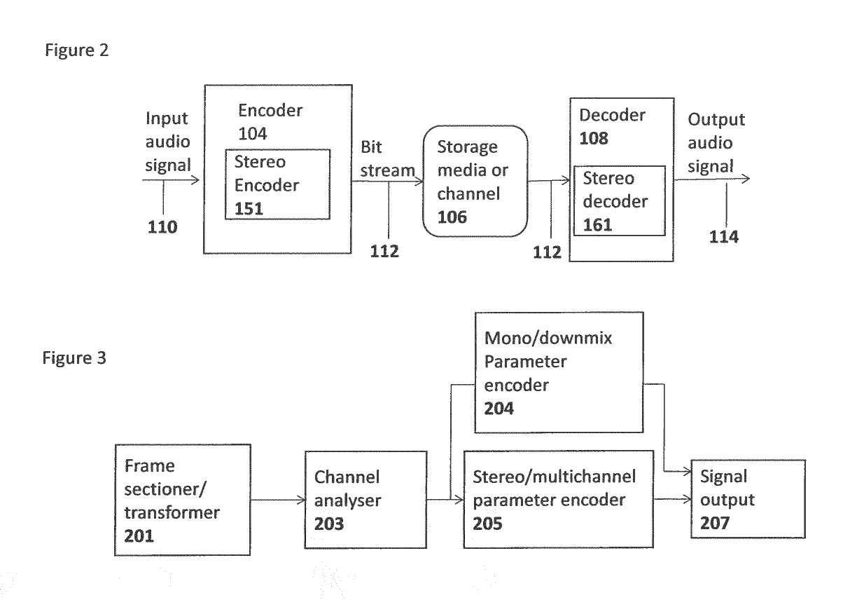

FIG. 2 shows schematically an audio codec system according to some embodiments;

FIG. 3 shows schematically an encoder as shown in FIG. 2 according to some embodiments;

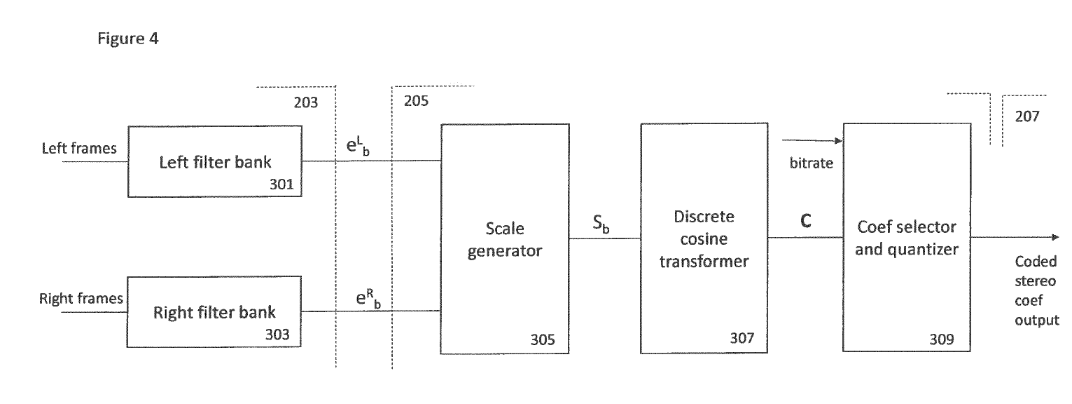

FIG. 4 shows schematically a stereo parameter encoder as shown in FIG. 3 in further detail according to some embodiments;

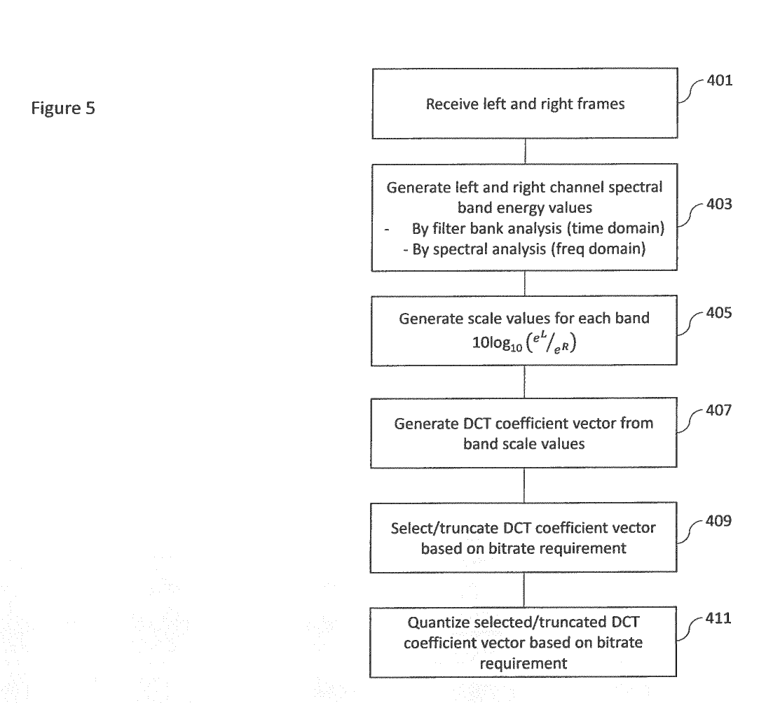

FIG. 5 shows a flow diagram illustrating the operation of the encoder shown in FIG. 3 according to some embodiments;

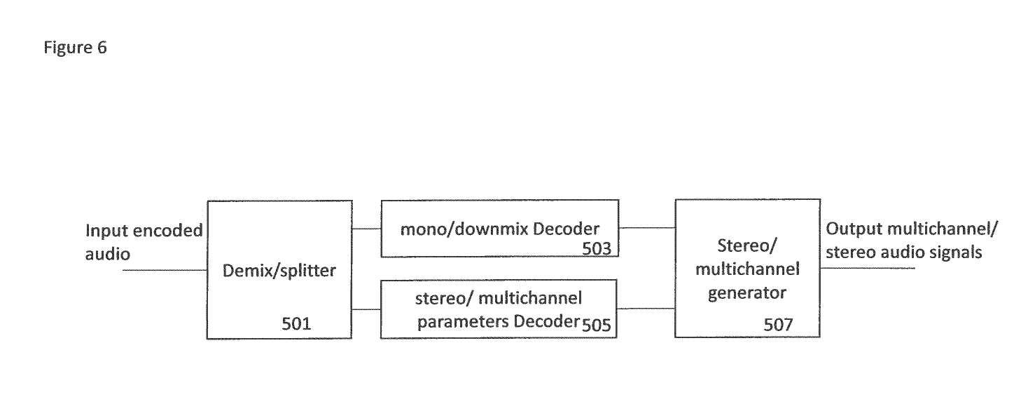

FIG. 6 shows schematically a decoder as shown in FIG. 2 according to some embodiments;

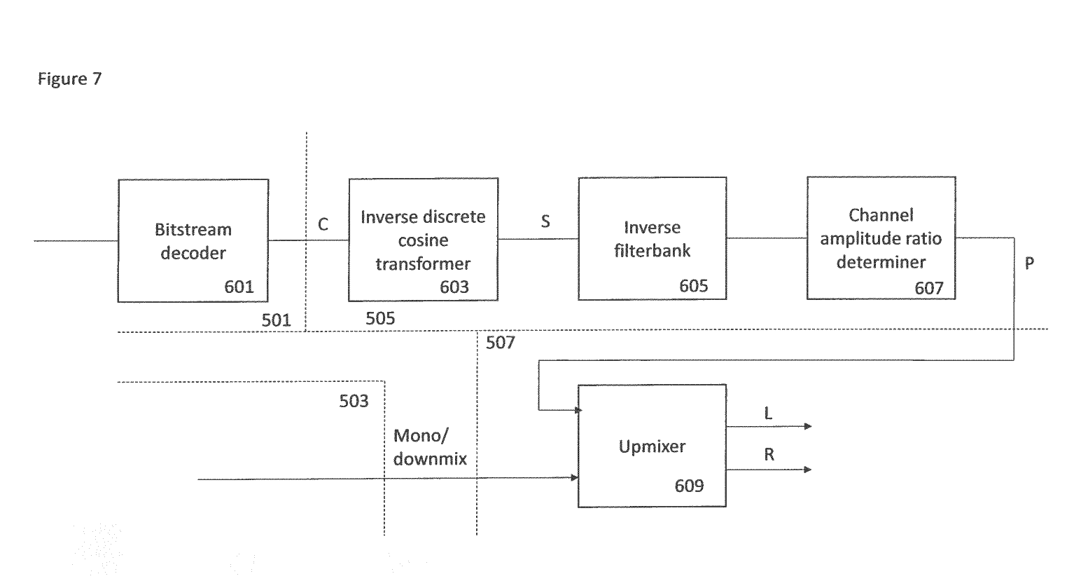

FIG. 7 shows schematically a stereo parameter decoder as shown in FIG. 6 in further detail according to some embodiments;

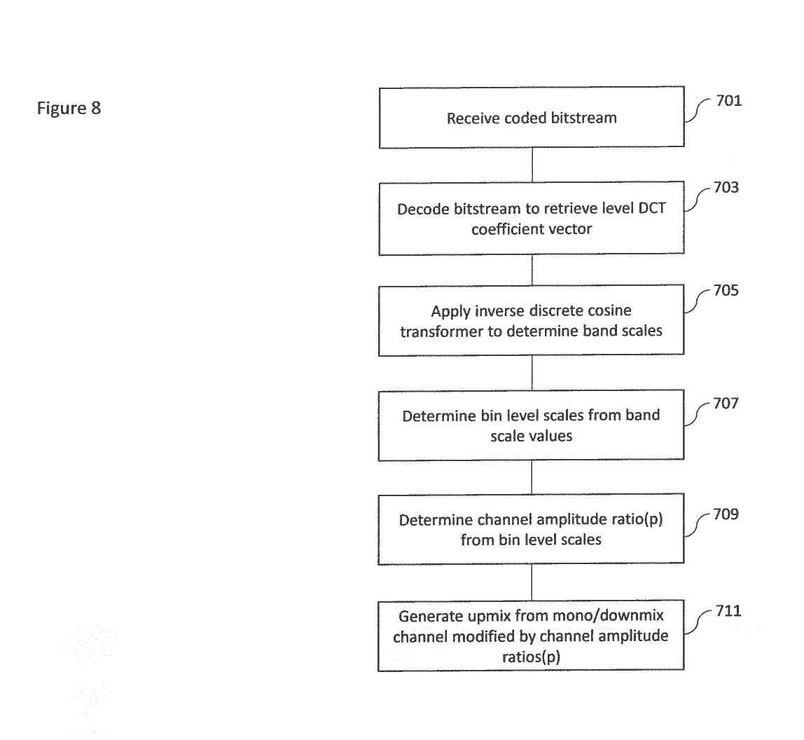

FIG. 8 shows a flow diagram illustrating the operation of the decoder shown in FIG. 5 according to some embodiments; and

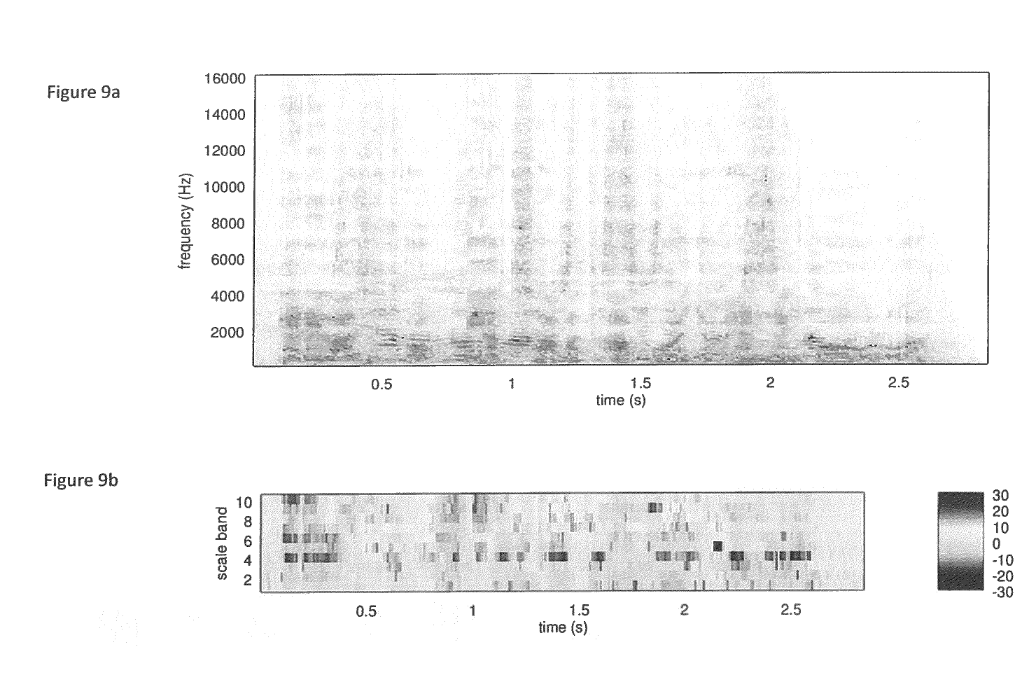

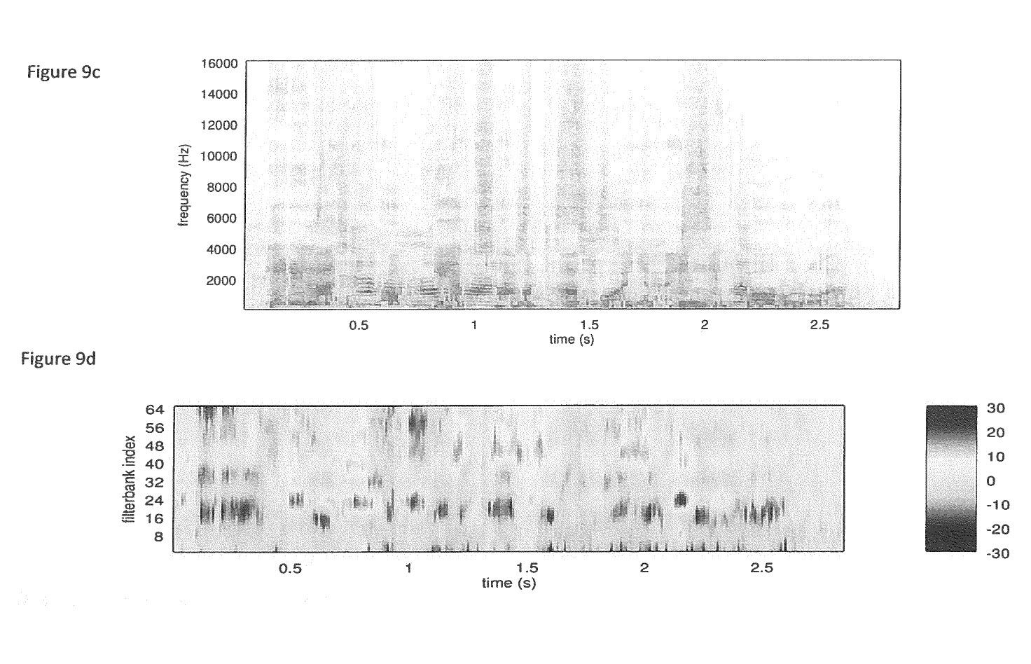

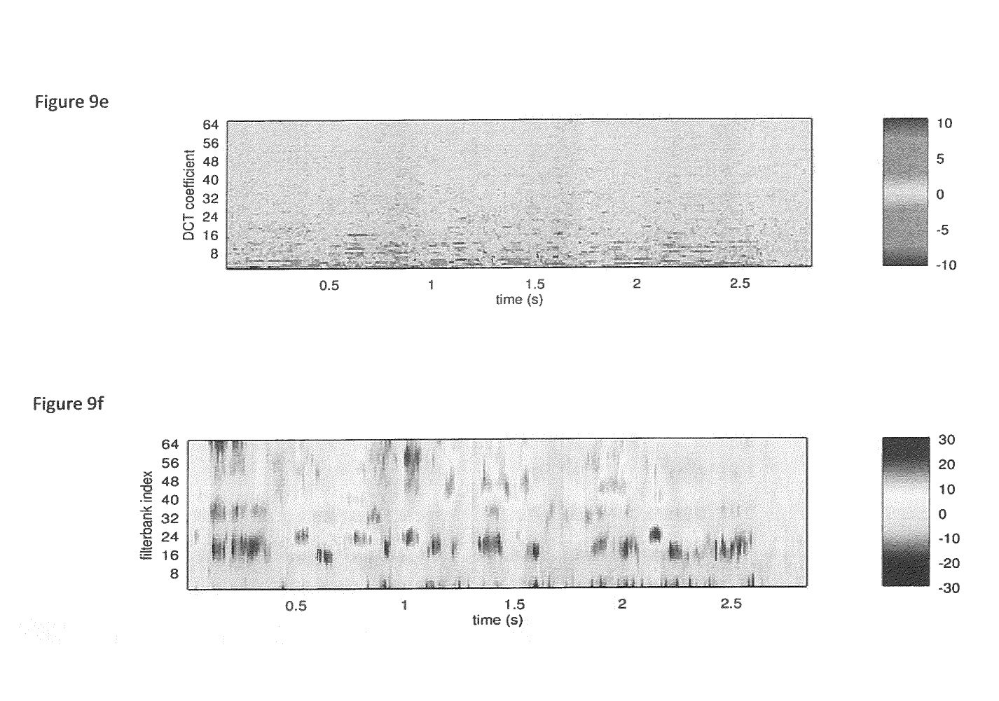

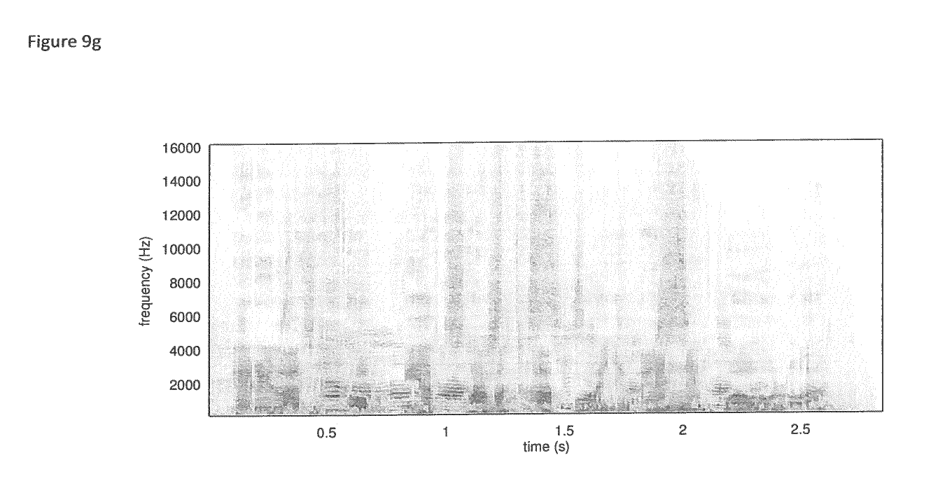

FIGS. 9a to 9g show example graphs of the output of the encoder/decoder according to some embodiments.

### DESCRIPTION OF SOME EMBODIMENTS OF THE APPLICATION

The following describes in more detail possible stereo and multichannel speech and audio codecs, including layered or scalable variable rate speech and audio codecs. In modelling of stereo and binaural recordings, energy balance between left and right channels forms one of the key cues for spatial perception in hearing. In low-bitrate audio coding, the approximate spatial image should be transmitted with a minimal number of parameters, which suffice to produce a plausible representation of the original stereo signal in the decoder.

The spatial position of sound sources is in part perceived by level differences (energy ratios) between signals arriving to the left and right ears. The spectral resolution of human hearing limits the number of necessary subband level parameters to approximately 30-40. However, this figure is still too high to transmit in low bitrate coding. Therefore it is necessary to reduce the information by using a representation, which maximally often manages to convey the approximate spatial image with significantly fewer parameters. However current low bit rate binaural extension layers produce a poor quality decoded binaural signal. This is caused by lack of resolution in the quantization of the binaural parameters (for example inter temporal differences ITD or delays and inter level differences ILD) or by the fact that not all subbands are represented by their corresponding binaural parameter in the encoded bitstream. This is because conventional bitrate constraints for the binaural extension has led to the quantization resolution of the parameters to be decreased (and therefore allowing fewer representation levels) or not all of the subbands are represented by a corresponding parameter. Furthermore typical level differences parameters are coded starting from the higher subbands downwards, for as many subbands as there are bits available thus generating binaural extensions which typically do not generate lower frequency representations.

The concept for the embodiments as described herein is to attempt to generate a stereo or multichannel audio coding that produces efficient high quality and low bit rate stereo (or multichannel) signal coding.

The concept for the embodiments as described herein is thus to generate a coding scheme applying discrete cosine transforms (DOT) to the left-right subband energy balance values, represented as logarithms of energy ratios (“scales”). The lowest DCT coefficients model the approximate left-right balance, whereafter further coefficients can then add finer details with a smaller effect on the overall perceived stereo image. For real-world data and human hearing, key information is typically compressed to the first coefficients.

In this regard reference is first made to FIG. 1 which shows a schematic block diagram of an exemplary electronic device or apparatus 10, which may incorporate a codec according to an embodiment of the application.

The apparatus 10 may for example be a mobile terminal or user equipment of a wireless communication system. In other embodiments the apparatus 10 may be an audio-video device such as video camera, a Television (TV) receiver, audio recorder or audio player such as a mp3 recorder/player, a media recorder (also known as a mp4 recorder/player), or any computer suitable for the processing of audio signals.

The electronic device or apparatus 10 in some embodiments comprises a microphone 11, which is linked via an analogue-to-digital converter (ADC) 14 to a processor 21. The processor 21 is further linked via a digital-to-analogue (DAC) converter 32 to loudspeakers 33. The processor 21 is further linked to a transceiver (RX/TX) 13, to a user interface (U) 15 and to a memory 22.

The processor 21 can in some embodiments be configured to execute various program codes. The implemented program codes in some embodiments comprise a multichannel or stereo encoding or decoding code as described herein. The implemented program codes 23 can in some embodiments be stored for example in the memory 22 for retrieval by the processor 21 whenever needed. The memory 22 could further provide a section 24 for storing data, for example data that has been encoded in accordance with the application.

The encoding and decoding code in embodiments can be implemented in hardware and/or firmware.

The user interface 15 enables a user to input commands to the electronic device 10, for example via a keypad, and/or to obtain information from the electronic device 10, for example via a display. In some embodiments a touch screen may provide both input and output functions for the user interface. The apparatus 10 in some embodiments comprises a transceiver 13 suitable for enabling communication with other apparatus, for example via a wireless communication network.

It is to be understood again that the structure of the apparatus 10 could be supplemented and varied in many ways.

A user of the apparatus 10 for example can use the microphones 11, or array of microphones, for inputting speech or other audio signals that are to be transmitted to some other apparatus or that are to be stored in the data section 24 of the memory 22. A corresponding application in some embodiments can be activated to this end by the user via the user interface 15. This application in these embodiments can be performed by the processor 21, causes the processor 21 to execute the encoding code stored in the memory 22.

The analogue-to-digital converter (ADC) 14 in some embodiments converts the input analogue audio signal into a digital audio signal and provides the digital audio signal to the processor 21. In some embodiments the microphone 11 can comprise an integrated microphone and ADC function and provide digital audio signals directly to the processor for processing.

The processor 21 in such embodiments then processes the digital audio signal in the same way as described with reference to the system shown in FIG. 2, the encoder shown in FIGS. 3 to 5 and the decoder as shown in FIGS. 6 to 8.

The resulting bit stream can in some embodiments be provided to the transceiver 13 for transmission to another apparatus. Alternatively, the coded audio data in some embodiments can be stored in the data section 24 of the memory 22, for instance for a later transmission or for a later presentation by the same apparatus 10.

The apparatus 10 in some embodiments can also receive a bit stream with correspondingly encoded data from another apparatus via the transceiver 13. In this example, the processor 21 may execute the decoding program code stored in the memory 22. The processor 21 in such embodiments decodes the received data, and provides the decoded data to a digital-to-analogue converter 32. The digital-to-analogue converter 32 converts the digital decoded data into analogue audio data and can in some embodiments output the analogue audio via the loudspeakers 33. Execution of the decoding program code in some embodiments can be triggered as well by an application called by the user via the user interface 15.

The received encoded data in some embodiment can also be stored instead of an immediate presentation via the loudspeakers 33 in the data section 24 of the memory 22, for instance for later decoding and presentation or decoding and forwarding to still another apparatus.

It would be appreciated that the schematic structures described hereafter and the method steps also described hereafter represent only a part of the operation of an audio codec and specifically part of a stereo encoder/decoder apparatus or method as exemplarily shown implemented in the apparatus shown in FIG. 1.

The general operation of audio codecs as employed by embodiments is shown in FIG. 2. General audio coding/decoding systems comprise both an encoder and a decoder, as illustrated schematically in FIG. 2. However, it would be understood that some embodiments can implement one of either the encoder or decoder, or both the encoder and decoder. Illustrated by FIG. 2 is a system 102 with an encoder 104 and in particular a stereo encoder 151, a storage or media channel 106 and a decoder 108 and in particular a stereo decoder 161. It would be understood that as described above some embodiments can comprise or implement one of the encoder 104 or decoder 108 or both the encoder 104 and decoder 108.

The encoder 104 compresses an input audio signal 110 producing a bit stream 112, which in some embodiments can be stored or transmitted through a media channel 106. The encoder 104 furthermore can comprise a stereo encoder 151 as part of the overall encoding operation. It is to be understood that the stereo encoder may be part of the overall encoder 104 or a separate encoding module. The encoder 104 can also comprise a multi-channel encoder that encodes more than two audio signals.

The bit stream 112 can be received within the decoder 108. The decoder 108 decompresses the bit stream 112 and produces an output audio signal 114. The decoder 108 can comprise a stereo decoder 161 as part of the overall decoding operation. It is to be understood that the stereo decoder 161 may be part of the overall decoder 108 or a separate decoding module. The decoder 108 can also comprise a multi-channel decoder that decodes more than two audio signals. The bit rate of the bit stream 112 and the quality of the output audio signal 114 in relation to the input signal 110 are the main features which define the performance of the coding system 102.

FIG. 3 shows schematically the encoder 104 according to some embodiments. In the examples provided herein the input audio signal is a two channel or stereo audio signal, which is analysed and a mono parameter representation is generated from a mono parameter encoder and stereo encoded parameters are generated from a stereo parameter encoder. However it would be understood that in some embodiments the input can be any number of channels which are analysed and a downmix parameter encoder generates a downmixed parameter representation and a channel extension parameter encoder generate extension channel parameters.

The concept for the embodiments as described herein is thus to determine and apply a multichannel (stereo) coding mode to produce efficient high quality and low bit rate real life multichannel (stereo) signal coding. To that respect with respect to FIG. 3 an example encoder 104 is shown according to some embodiments.

The encoder 104 in some embodiments comprises a frame sectioner 201. The frame sectioner 201 is configured to receive the left and right (or more generally any multi-channel audio representation) input audio signals and generate sections of time or frequency domain representations of these audio signals to be analysed and encoded. These representations can be passed to the channel analyser 203.

The frame sectioner 201 in some embodiments can further be configured to window these frames or sections of audio signal data according to any suitable windowing function. For example the frame sectioner 201 can be configured to generate frames of 20 ms which overlap preceding and succeeding frames by 10 ms each.

In some embodiments the frame sectioner can be configured to perform any suitable time to frequency domain transformation on the audio signal data in order to generate frequency domain representations. For example the time to frequency domain transformation can be a discrete Fourier transform (DFT), Fast Fourier transform (FFT), modified discrete cosine transform (MDCT). In the following examples a Fast Fourier Transform (FFT) is used.

In some embodiments the encoder 104 can comprise a channel analyser 203 or means for analysing at least one audio signal. The channel analyser 203 for example may be configured to receive the time or frequency domain representations and analyse these representations to generate suitable parameters which may be used to generate the encoded mono parameters and the encoded stereo parameters. In some embodiments the channel analyser 203 may be configured to generate separate frequency band representations. This may be performed in the time domain by the application of filterbanks or in the frequency domain selecting the suitable outputs from the frequency domain transformer. For example in some embodiments a frequency domain output from the frame sectioner can be further processed to generate separate frequency band domain representations (sub-band representations) of each input channel audio signal data. These frequency bands can be arranged in any suitable manner. For example these bands can be linearly spaced, or be perceptual or psychoacoustically allocated. These bands may then be analysed.

For example in some embodiments the channel analyser 203 may comprise an inter-channel delay or shift determiner (or means for determining a shift) configured to determine a delay or time shift between the channels (and in some embodiments for a sub-band). The delay or shift determiner may be implemented by determining a delay value which maximizes a real part of a correlation between the audio signals. This delay or shift value may then be applied to one of the audio channels to provide a temporal alignment between the channels. However any suitable way to determine a delay or shift value between channels may be employed. Furthermore in some embodiments the delay or shift or inter-channel temporal difference (ITD) value may be passed to the stereo/multichannel parameter encoder 205 to be encoded.

Furthermore in some embodiments the channel analyser 203 may comprise a coherence determiner configured to determine coherence parameters. These coherence parameters may be passed to the stereo/multichannel parameter encoder 205 to be encoded.

Furthermore in some embodiments the channel analyser 203 may be configured to determine energy components for the frequency bands of the left and right channels. These may in some embodiments be the time aligned channels.

The channel analyser 203 may then be configured to output the time or frequency representations and the analysis results (for example the delay and energy values) to the mono/downmix parameter encoder 204 and the stereo/multichannel parameter encoder 205.

In some embodiments the apparatus comprises a mono (or downmix) parameter encoder 204. The mono/downmix parameter encoder 204 may be configured to receive the left and right channel representations and furthermore the channel analysis output parameters and be configured to generate a suitable mono or downmixed encoded audio signal. The mono/downmix parameter encoder 204 may for example apply the time shift value to one of the audio channels to provide a temporal alignment between the channels where the channels are not aligned by the channel analyser. The mono (downmix) parameter encoder 204 may then generate an ‘aligned’ mono (or downmix) channel which is representative of the audio signals. In other words generate a mono (downmix) channel signal which represents an aligned stereo (multichannel) audio signal. For example in some embodiments the delayed channel and other channel audio signals are averaged to generate a mono channel signal. However it would be understood that in some embodiments any suitable mono channel generating method can be implemented.

It would be understood that in some embodiments the mono channel generator or suitable means for generating audio channels can be replaced by or assisted by a ‘reduced’ (or downmix) channel number generator configured to generate a smaller number of output audio channels than input audio channels. Thus for example in some multichannel audio signal examples where the number of input audio signal channels is greater than two the ‘mono channel generator’ is configured to generate more than one channel audio signal but fewer than the number of input channels.

The mono (downmix) parameter encoder 204 can then in some embodiments encode the generated mono (downmix) channel audio signal (or reduced number of channels) using any suitable encoding format. For example in some embodiments the mono (downmix) channel audio signal can be encoded using an Enhanced Voice Service (EVS) mono (or multiple mono) channel encoded form, which may contain a bit stream interoperable version of the Adaptive Multi-Rate—Wide Band (AMR-WB) codec.

The encoded mono (downmix) channel signal can then be output to a signal output 207.

In some embodiments the encoder 104 comprises a stereo (or extension or multi-channel) parameter encoder 205 (or means for encoding an encoded stereo parameter). In the following example the multi-channel parameter encoder is a stereo parameter encoder 205 or suitable means for encoding the multi-channel parameters. The stereo/multichannel parameter encoder 205 can be configured to determine some stereo/multi-channel parameters such as the inter-channel level difference (ILD) parameters described hereafter. Furthermore in some embodiments the stereo/multichannel parameter encoder may be configured to receive previously determined parameters such as the inter-channel temporal difference (ITD) (or delay or shift values) and coherence parameters and encode these values. In the following examples the stereo/multichannel parameter encoder 205 is shown with respect to the generation and encoding of inter-channel level difference parameters but it is understood that in some embodiments the output from the stereo/multichannel parameter encoder 205 comprises both inter-channel level difference (ILD) parameters such as discussed hereafter, inter-channel temporal difference (ITD) and coherence parameters.

The stereo parameter encoder 205 can then in some embodiments be configured to perform a quantization on the parameters and furthermore encode the parameters so that they can be output (either to be stored on the apparatus or passed to a further apparatus) to the signal output 207.

In some embodiments encoder 104 comprises a signal output 207. For example the signal output 207 may be a multiplexer which is configured to receive and combine the output of the stereo parameter encoder 205 and the mono parameter encoder to form a single stream or output. In some embodiments the signal output 207 is configured to output the encoded mono (downmix) channel signal separately from the stereo parameter encoder 205.

With respect to FIG. 4 an example stereo parameter encoder 205 is shown in further detail. FIG. 4 for example shows the left and right channel audio signal frames (generated by the frame sectioner) being passed to a channel analyser 203 comprising a left filter bank 301 and a right filter bank 303.

The left filter bank 301 is configured to convert in the time domain left channel frame representations into a series of band energy values and output these to a stereo parameter encoder and specifically a scale generator 305.

The right filter bank 303 is configured to convert in the time domain right channel frame representations into a series of band energy representations and output these to a stereo parameter encoder and specifically a scale generator 305. For example given F-dimensional vectors of left and right channel DFT magnitudes, d^{L} and d^{R}, and a set of B (squared) frequency responses of equivalent length, a^{(b)} (b∈[0, B−1]) the filtered band energies of left and right channels, e_{\dot{o}}^{L}, e_{\dot{o}}^{R} are computed as

$${e}_{b}^{L} = {\sum }_{f = 0}^{F - 1} {( {d}_{f}^{L} )}^{2} {a}_{f}^{( b )}$$

$${e}_{b}^{R} = {\sum }_{f = 0}^{F - 1} {( {d}_{f}^{R} )}^{2} {a}_{f}^{( b )}$$

together denoted by length B vectors e^{L} and e^{R}.

The stereo parameter encoder 205 in some embodiments comprises a scale generator 305. The scale generator 305 is configured to receive the left channel energy representations e^{L} and the right channel energy representations e^{R} and from these generate scale values. The scale values may be output to a discrete cosine transformer 307.

For example the left-right scale values s_{b}, measured in decibels, may be computed as

$${s}_{b} = 10 {log}_{10} \frac{{e}_{b}^{L}}{{e}_{b}^{R}}$$

forming the B-dimensional scale vector s.

In some embodiments the stereo parameter encoder 205 comprises a discrete cosine transformer 307 configured to receive the scale values and output a cosine transformed vector of the scale values to a coefficient selector and quantizer 309.

The Discrete Cosine Transform from s to a coefficient vector c (with elements cₖk∈[0, B−1]) may be defined as

$${c}_{k} = {w}_{k} {\sum }_{b = 0}^{B - 1} {s}_{b} cos [ \frac{π k}{B} ( b + \frac{1}{2} ) ]$$

where wₖ=1/B for k=0 and \sqrt{2}/B otherwise, in a convention where the scaling by the vector length B is applied entirely in the forward-transform stage.

In some embodiments the stereo parameter encoder 205 comprises a coefficient selector and quantizer 309. The coefficient selector and quantizer 309 may be configured to receive to receive the discrete cosine transformed scale values and a bitrate value and then select coefficients or truncate the coefficient vector c. Furthermore in some embodiments the coefficient selector and quantizer 309 may be configured to quantize the vector according to any suitable quantisation method. The coefficient selector and quantizer 309 may then output of the encoded stereo coefficient outputs to the signal output 207. In other words based on the available bit allocation for scale information, the encoder selects a reduced number of DCT coefficients and applies a quantisation scheme to them to achieve a limited resolution representation of the c vector, concentrating on its lowest coefficients. The resulting quantised data may then be passed to the bit stream along other stereo parameters and a single mono-coded audio stream

With respect to FIG. 5 a flow diagram of the operations of the encoder 104 and the stereo parameter encoder 205 in detail is shown. FIG. 5 thus shows the method beginning with receiving the left and right channel frames.

The operation of receiving the left and right channel frames is shown in FIG. 5 by step 401.

The method then comprises generating left and right channel spectral band energy values. The spectral band energy values can be determined by the filterbank analysis in the time domain such as shown in FIG. 4 or by spectral analysis within the frequency domain as described previously.

The operation of generating the left and right channel spectral band energy values is shown in FIG. 5 by step 403.

The method may further comprise generating scale values for the spectral bands.

The operation of generating the scale value to the spectral bands is shown in FIG. 5 by step 405.

The method then comprises generating a discrete cosine transform coefficient vector from the band scale values by applying a discrete cosine transform to the scale values for the spectral bands.

The operation of generating the discrete cosine transform coefficient factors from the band scale values is shown in FIG. 5 by step 407.

The method may then comprise selecting and truncating the discrete cosine transform (DCT) coefficient vector based on an available bit rate for signalling the scale values.

The operation of selecting or truncating the DCT coefficient vector based on the available bitrate or bitrate requirement is shown in FIG. 5 by step 409.

The method may further comprises quantizing the selected/truncated DCT coefficients based on an available bit rate for signalling the scale values and outputting the quantized vector.

The operation of quantizing the selected/truncated DCT coefficient vector based on the bit rate is shown in FIG. 5 by step 411.

In order to fully show the operations of the codec FIGS. 6 to 8 show a decoder and the operation of the decoder according to some embodiments. In the following example the decoder is a stereo decoder configured to receive a mono channel encoded audio signal and stereo channel extension or stereo parameters, however it would be understood that the decoder is a multichannel decoder configured to receive any number of channel encoded audio signals (downmix channels) and channel extension parameters.

FIG. 6 shows an overview of a suitable decoder. In some embodiments the decoder 108 comprises a Demix/Splitter 501. The Demix/Splitter 501 (or means for decoding) is configured in some embodiments to receive the encoded audio signal and output an encoded mono (or downmix) channel signal to a mono decoder 503 and further output the discrete cosine transformed scale coefficient vector c to the stereo decoder 505.

The decoder 108 may furthermore comprise a mono decoder 503 configured to receive the encoded mono channel signal from the demix/splitter 501. The mono decoder 503 may then decode the encoded mono channel signal using the inverse or reverse of the encoding applied by the mono/downmix encoder. The decoded mono channel signal may then be passed to the stereo (multichannel) channel generator 507.

The stereo decoder 505 may be configured to receive the discrete cosine transformed scale coefficient vector c and generate parameters which may be used to enable the stereo generator 507 to generate the stereo (left and right) channels from the mono channel signal.

The stereo (or multichannel) generator 507 may be configured to receive the mono (or downmix) signal and the stereo (multichannel) parameters and from these generate the stereo left channel and right channel by the application of the stereo parameters to the mono signal according to any suitable method. Furthermore in some embodiments the stereo generator 507 may apply a delay to one (or more than one) channel to restore the delay determined within the encoder.

With respect to FIG. 7 an example stereo decoder 505 is shown in further detail.

The stereo decoder 505 is shown in FIG. 7 having received the discrete cosine transformed scale coefficient vector c from the Demix/Splitter 501 and specifically a demix/splitter comprising a bitstream decoder 601 configured to output the discrete cosine transformed scale coefficient vector.

The stereo decoder in some embodiments comprises an inverse discrete cosine transformer 603. The inverse discrete cosine transformer 603 may be configured to receive the coefficient vector and perform an inverse discrete transform on the vector to generate scale value s for the spectral sub-bands. The scale values s may be output to an inverse filter bank 605. The corresponding Inverse DCT may for example be represented by:

$${s}_{b} = {c}_{0} + \sqrt{2} {\sum }_{b = 0}^{B - 1} {c}_{k} cos [ \frac{π k}{B} ( b + \frac{1}{2} ) ] .$$

In some embodiments no vector length scaling is performed at this stage. Consequently, the range of c coefficient values only reflects the range of s values, not the vector length, which permits quantisation of c using a fixed numerical range.

The stereo decoder 505 may comprise an inverse filterbank 605. The inverse filterbank may be configured to receive the scale values s and generate bin level scales ŝ from the scale values. The bin level scales ŝ may be output to a channel amplitude ratio determiner 607. In some embodiments the filterbank-resolution (length B) scale vector s is upsampled to a full spectral resolution (length F) vector ŝ as

$${\hat{s}}_{f} = {\sum }_{b = 0}^{B - 1} {s}_{b} \cdot {\hat{a}}_{f}^{( b )}$$

where the filter responses â^{(\dot{o})} have been normalised so that in each DFT frequency bin f the sum over a_{f}^{(b)} values is.

In some embodiments the stereo decoder 505 comprises a channel amplitude ratio determiner 607. The channel amplitude ratio determiner 607 may be configured to receive the bin level scales ŝ and determine a channel amplitude ratios p. The channel amplitude ratios p can be output to a suitable stereo channel generator 507. The ratios for example may be generated from

$${p}_{f} = {10}^{( \frac{\text{?}}{10} )}$$

$$\text{?} \text{indicates text missing or illegible when filed}$$

The stereo channel generator 507 may comprise an upmixer 609 configured to receive the mono channel (from the mono channel decoder 503) and the channel amplitude ratios p. The upmixer 609 may then apply the channel amplitude ratios p to the mono channel signal to generate the left and right stereo channels. For example given the mono channel DFT magnitudes d^{M} (length F), level upmixing to d^{L} and d^{R} may be performed by computing

$${d}_{f}^{L} = {d}_{f}^{M} \sqrt{\frac{{p}_{f}}{{p}_{f} + 1}}$$

$${d}_{f}^{R} = {d}_{f}^{M} \sqrt{\frac{1}{{p}_{f} + 1}}$$

assuming that the numerical scales of d^{M}, d^{L} and d^{R} are equal. These vectors may be upsampled to full spectral resolution. The amplitude ratio between left and right channels is thus solved for each frequency with the rest of stereo information to upmix the mono steam to a stereo output. In some embodiments any delay between the channels may furthermore be introduced by the upmixer 609. For example the upmixer may furthermore receive from the bitstream decoder a delay parameter determined and supplied by the encoder. The delay parameter may determine a time difference between the channels and a delay applied to at least one of the channels to regenerate the inter-temporal difference between the channels.

The stereo channels may then be output.

With respect to FIG. 8 the operations of the stereo decoder 505 such as shown in FIG. 7 is shown. The method may comprise receiving the encoded bitstream.

The operation of receiving the encoded bitstream is shown in FIG. 8 by step 701.

The method may then comprise decoding the bitstream to retrieve the discrete cosine transformed scale coefficient vector c.

The operation of decoding the bitstream to retrieve the DCT scale coefficient vector is shown in FIG. 8 by step 703.

Furthermore the method may comprise applying an inverse discrete cosine transform to determine the band scale values.

The operation of applying the inverse discrete cosine transform to determine the band scale values is shown in FIG. 8 by step 705.

The method may further comprise determining the bin level scale values from the band scale values.

The operation of determining the bin level scale values from the band scale values is shown in FIG. 8 by step 707.

The method may further comprise determining the channel amplitude ratios from the bin level scales values.

The operation of determining the channel amplitude ratios from the bin level scale values is shown in FIG. 8 by step 709.

The method may then further comprise generating the stereo channels from the mono channel modified by the channel amplitude ratios.

The operation of generating an upmix, such as a left and right channel audio signals from the mono channel modified by the channel amplitude ratios is shown in FIG. 8 by step 711.

With respect to FIGS. 9a to 9g as series of graphs showing the output of a simulated stereo channel unencoded, conventionally encoded and encoded according to some embodiments is shown. To help visualize the effect of the implementation of the method as described herein the figures show the output based on a stereo sound file with two overlapping subjects: a female speaker located predominantly on the left side and a male speaker on the right. The hue of all plots represents stereo balance where the darker the image the greater the spectral activity from the centre.

With respect to FIG. 9a a high-resolution input spectrogram with shading reflecting stereo balance and stronger colours reflecting more total spectral activity. The white areas reflect regions with no significant spectral activity and darker areas reflecting spectral activity for the left and right channels corresponding to the female and the male subject can be seen, overlapping temporally most of the time but often in different spectral ranges

FIG. 9b furthermore shows an example of a conventional inter-level difference analysis using ten sub-bands. Thus effectively reduces the spectral resolution to a small fraction to the original resolution. FIG. 9c then shows a spectrogram of a mono-downmixed middle channel is upmixed back to stereo using the low resolution data shown in FIG. 9b. The inter-level difference sub-band borders produce blocking in the spectral direction.

FIG. 9d shows an output from a filterbank used for DCT-based analysis using 64 bands.

FIG. 9e shows the output of applying spectral direction DCT to the output of the filterbank as shown in FIG. 9d. As it can be seen the energy is mostly concentrated on the lowest DCT coefficients and in particular, the first coefficient reflects whether most of the energy of each frame is on the left or on the right.

FIG. 9f shows an approximation of the medium-resolution spectrogram of FIG. 9d, after an inverse DCT has been applied to the lowest ten DCT coefficients from FIG. 9e (and discarding the rest).

Furthermore FIG. 9g shows a full-resolution spectrogram of an upmix produced by proposed DCT, IDCT and filterbank operations. This output is comparable to the original spectrogram as show in n FIG. 9a and the conventional upmix as shown in FIG. 9c. Although some fine detail of the original stereo image as shown in FIG. 9a is lost due to lossy parameterisation, the main features of stereo balance remain with no blocking artifacts such as shown in FIG. 9c.

Although the above examples describe embodiments of the application operating within a codec, it would be appreciated that the invention as described below may be implemented as part of any audio (or speech) codec, including any variable rate/adaptive rate audio (or speech) codec. Thus, for example, embodiments of the application may be implemented in an audio codec which may implement audio coding over fixed or wired communication paths.

Thus user equipment may comprise an audio codec such as those described in embodiments of the application above.

It shall be appreciated that the term user equipment is intended to cover any suitable type of wireless user equipment, such as mobile telephones, portable data processing devices or portable web browsers.

Furthermore elements of a public land mobile network (PLMN) may also comprise audio codecs as described above.

In general, the various embodiments of the application may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the application may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this application may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the application may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

As used in this application, the term ‘circuitry’ refers to all of the following:

(a) hardware-only circuit implementations (such as implementations in only analogue and/or digital circuitry) and

(b) to combinations of circuits and software (and/or firmware), such as: (i) to a combination of processor(s) or (ii) to portions of processor(s)/software (including digital signal processor(s)), software, and memory(ies) that work together to cause an apparatus, such as a mobile phone or server, to perform various functions and

(c) to circuits, such as a microprocessor(s) or a portion of a microprocessor(s), that require software or firmware for operation, even if the software or firmware is not physically present.

This definition of ‘circuitry’ applies to all uses of this term in this application, including any claims. As a further example, as used in this application, the term ‘circuitry’ would also cover an implementation of merely a processor (or multiple processors) or portion of a processor and its (or their) accompanying software and/or firmware. The term ‘circuitry’ would also cover, for example and if applicable to the particular claim element, a baseband integrated circuit or applications processor integrated circuit for a mobile phone or similar integrated circuit in server, a cellular network device, or other network device.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1-26. (canceled)

27. An apparatus comprising at least one processor and at least one memory including computer code for one or more programs, the at least one memory and the computer code configured to with the at least one processor cause the apparatus to at least:
determine a plurality of band energy scale values for a pair of audio signals;
transform the plurality of band energy scale values using a discrete cosine transform to generate a plurality of coefficient values; and
select a sub-set of the plurality of coefficient values to generate a representation of a level difference between the pair of audio signals.

28. The apparatus as claimed in claim 27, further caused to:
quantize the sub-set of the plurality of coefficient values; and
output or store the quantized sub-set of the plurality of coefficient values as the representation of a level difference between the pair of audio signals.

29. The apparatus as claimed in claim 27, further caused to output or store the sub-set of the plurality of coefficient values as the representation of a level difference between the pair of audio signals.

30. The apparatus as claimed in claim 27, further caused to
determine on a band by band basis a first plurality of band energy values from a first of the pair of audio signals; and
determine on a band by band basis a second plurality of band energy values from a second of the pair of audio signals, wherein the apparatus caused to determine the plurality of band energy scale values for the pair of audio signals is caused to determine on a band by band basis a ratio of the first plurality of band energy values against the second plurality of band energy values.

31. The apparatus as claimed in claim 30, further caused to:
determine first audio signal band representations from the first of the pair of audio signals; and
determine second audio signal band representations from the second of the pair of audio signals, wherein the apparatus caused to determine on a band by band basis the first plurality of band energy values from a first of the pair of audio signals is caused to on a band by band basis combine the first audio signal band representations, and the apparatus caused to determine on a band by band basis the second plurality of band energy values from a second of the pair of audio signals is caused to on a band by band basis combine the second audio signal band representations.

32. The apparatus as claimed in claim 31, wherein the apparatus caused to determine on a band by band basis a first plurality of band energy values from the first of the pair of audio signals may is caused to pass the first audio signal through a first filterbank to generate the first plurality of band energy values, and the apparatus caused to determine on a band by band basis the second plurality of band energy values from the second of the pair of audio signals is caused to pass the second audio signal through a second filterbank to generate the second plurality of band energy values.

33. The apparatus as claimed in claim 32, wherein the apparatus caused to determine the first plurality of band energy values for the first of the pair of audio signals is caused to determine
$${e}_{b}^{L} = {\sum }_{f = 0}^{F - 1} {( {d}_{f}^{L} )}^{2} {a}_{f}^{( b )} ,$$
and
the apparatus caused to determine the second plurality of band energy values for the second of the pair of audio signals is caused to determine
$${e}_{b}^{R} = {\sum }_{f = 0}^{F - 1} {( {d}_{f}^{R} )}^{2} {a}_{f}^{( b )}$$
where e_{\dot{o}}^{L}, are filtered band energies of the first audio signal of the pair of audio signals, e_{\dot{o}}^{R} are filtered band energies of the second signal of the pair of audio signals, d_{f}^{L} are magnitudes of the first audio signal, d_{f}^{R}, are magnitudes of the second audio signal, a_{f}^{(b)} are a set of B (squared) frequency responses of equivalent length, where a number of bands are b∈[0, B−1].

34. The apparatus as claimed in claim 33, wherein the apparatus caused to determine a plurality of band energy scale values for a pair of audio signals is further caused to determine
$${s}_{b} = 10 {log}_{10} \frac{{e}_{b}^{L}}{{e}_{b}^{R}}$$
where s_{b} are the plurality of band energy scale values.

35. The apparatus as claimed in claim 34, wherein the apparatus caused to transform the band energy scale values using a discrete cosine transform to generate a plurality of coefficient values is further caused to perform determine
$${c}_{k} = {w}_{k} {\sum }_{b = 0}^{B - 1} {s}_{b} cos [ \frac{π k}{B} ( b + \frac{1}{2} ) ]$$
where cₖ is the coefficient values and wₖ=1/B for k=0 and \sqrt{2}/B otherwise.

36. An apparatus comprising at least one processor and at least one memory including computer code for one or more programs, the at least one memory and the computer code configured to with the at least one processor cause the apparatus to at least:
determine from an encoded audio signal: a plurality of coefficient values representing discrete cosine transformed band energy scale values; and a downmixed audio signal;
inverse cosine transform the plurality of coefficient values to generate a plurality of band energy scale values; and
generate a pair of audio signals by applying the plurality of band energy scale values to the downmixed audio signal.

37. The apparatus as claimed in claim 36 wherein the apparatus caused to generate a pair of audio signals by applying the plurality of band energy scale values to the downmixed audio signal is caused to upsample the plurality of band energy scale values to a full spectral resolution.

38. The apparatus as claimed in claim 36 wherein the apparatus caused to generate a pair of audio signals by applying the plurality of band energy scale values to the downmixed audio signal is caused to:
generate an amplitude ratio for each band from the plurality of band energy scale values;
apply the amplitude ratio for each band to an associated downmixed audio signal band to generate for each of the pair of audio signals a plurality of audio signal bands; and
combine for each of the pair of audio signals the plurality of audio signal bands.

39. A method comprising:
determining a plurality of band energy scale values for a pair of audio signals;
transforming the plurality of band energy scale values using a discrete cosine transform to generate a plurality of coefficient values;
selecting a sub-set of the plurality of coefficient values to generate a representation of a level difference between the pair of audio signals.

40. The method as claimed in claim 39, further comprising outputting or storing the sub-set of the plurality of coefficient values as the representation of a level difference between the pair of audio signals.

41. The method as claimed in claim 39, further comprising:
determining on a band by band basis a first plurality of band energy values from a first of the pair of audio signals; and
determining on a band by band basis a second plurality of band energy values from a second of the pair of audio signals, wherein determining the plurality of band energy scale values for the pair of audio signals comprises determining on a band by band basis a ratio of the first plurality of band energy values against the second plurality of band energy values.

42. The method as claimed in claim 39, further comprising:
determining first audio signal band representations from the first of the pair of audio signals; and
determining second audio signal band representations from the second of the pair of audio signals, wherein determining on a band by band basis the first plurality of band energy values from a first of the pair of audio signals comprises on a band by band basis combining the first audio signal band representations, and determining on a band by band basis the second plurality of band energy values from a second of the pair of audio signals comprises on a band by band basis combining the second audio signal band representations.

43. The method as claimed in claim 42, wherein determining on a band by band basis a first plurality of band energy values from the first of the pair of audio signals comprises passing the first audio signal through a first filterbank to generate the first plurality of band energy values, and determining on a band by band basis the second plurality of band energy values from the second of the pair of audio signals comprises passing the second audio signal through a second filterbank to generate the second plurality of band energy values.

44. The method as claimed in claim 43, wherein determining the first plurality of band energy values for the first of the pair of audio signals comprises determining
$${e}_{b}^{L} = {\sum }_{f = 0}^{F - 1} {( {d}_{f}^{L} )}^{2} {a}_{f}^{( b )} ,$$
and
determining the second plurality of band energy values for the second of the pair of audio signals comprises determining
$${e}_{b}^{R} = {\sum }_{f = 0}^{F - 1} {( {d}_{f}^{R} )}^{2} {a}_{f}^{( b )}$$
where e_{\dot{o}}^{L}, are filtered band energies of the first audio signal of the pair of audio signals, e_{\dot{o}}^{R} are filtered band energies of the second signal of the pair of audio signals, d_{f}^{L} are magnitudes of the first audio signal, d_{f}^{R}, are magnitudes of the second audio signal, a_{f}^{(b)} are a set of B (squared) frequency responses of equivalent length, where a number of bands are b∈[0, B−1].

45. The method as claimed in claim 44 wherein determining the plurality of band energy scale values for a pair of audio signals comprises determining
$${s}_{b} = 10 {log}_{10} \frac{{e}_{b}^{L}}{{e}_{b}^{R}}$$
where s_{b} are the plurality of band energy scale values.

46. The method as claimed in claim 45, wherein transforming the plurality of band energy scale values using a discrete cosine transform to generate a plurality of coefficient values comprises determining
$${c}_{k} = {w}_{k} {\sum }_{b = 0}^{B - 1} {s}_{b} cos [ \frac{π k}{B} ( b + \frac{1}{2} ) ]$$
where cₖ is the coefficient values and wₖ=1/B for k=0 and \sqrt{2}/B otherwise.

47. A method comprising:
determining from an encoded audio signal: a plurality of coefficient values representing discrete cosine transformed band energy scale values; and a downmixed audio signal;
inverse cosine transforming the plurality of coefficient values to generate a plurality of band energy scale values; and
generating a pair of audio signals by applying the plurality of band energy scale values to the downmixed audio signal.
